(19) United States
(12) Patent Application Publication
(10) Pub. No.: US 2008/0190535 A1
(43) Pub. Date: Aug. 14, 2008

(54) Hub-bearing assembly allowing pressurized air to be supplied to the tyre of a vehicle wheel

(75) Inventor: Cristian Concu, Torino (IT)

Correspondence Address: MERCHANT & GOULD PC, P.O. BOX 2903, MINNEAPOLIS, MN, 55402-0903, US

(73) Assignee: Aktiebolaget SKF, Goteborg (SE)

(21) Appl. No.: 11/827,028

(22) Filed: Jul. 9, 2007

(30) Foreign Application Priority Data
Jul. 11, 2006 (EP) 06116989.2

(51) Int. Cl. B60C 29/00; B60B 27/00; F16C 19/04

(52) U.S. Cl. 152/416; 384/490; 301/105.1

(57) ABSTRACT

A hub-bearing unit has a rotatable hub fixable to the wheel of the vehicle and a stationary bearing race fixable to the vehicle for rotatably supporting the hub about an axis. An air cavity is formed in the hub with a radial passage for letting pressurized air into the cavity and an outlet for conveying pressurized air from this cavity to the tyre. The assembly includes a cam integral with the stationary race and cooperating with a piston accommodated in the radial passage. Rotation of the hub causes the piston to reciprocate along the passage and let pressurized air into the cavity.

### BACKGROUND OF THE INVENTION

The present invention refers to a hub-bearing assembly allowing pressurized air to be supplied to the tyre of a vehicle wheel.

There are known hub-bearing units allowing to inflate air pressurized by a source of pressurized air mounted on board of the vehicle to the tyre in order to adjust and/or monitor the air pressure of the tyres. In some known solutions, as for example in U.S. Pat. No. 5,642,946 and EP-A-0 362 921, radial bores are formed in the outer and inner races of the bearing for allowing pressurized air to pass to the rotating part of the hub-bearing assembly. Air pressurized by a pressurized air source mounted on board of the vehicle, which may be part of an automatic system or a system controlled by the driver, passes through special ducts obtained in the suspension standard of the wheel where the bearing is housed, then in a duct formed in the non-rotatable bearing race, then in an intermediate annular chamber between the rotatable and stationary races, then through one or more ducts formed in the hub or the rotatable race, and from here is conveyed through other ducts to the wheel rim and finally the tyre. The inlet of pressurized air takes place very near the rolling bodies in the hub-bearing assembly. Therefore it is necessary to fit special high duty sealing devices preventing pressurized air from penetrating directly into the inner part of the bearing, where the lubricating grease for lubricating the rolling bodies and the raceways. These sealing devices are expensive and develop considerable friction. Moreover, the passage of pressurized air through the bearing can shorten considerably its life, in case the above-mentioned sealing devices should be or become faulty.

### SUMMARY OF THE INVENTION

It is an object of the present invention to provide a hubbearing assembly allowing pressurized air to be supplied to the tyre without needing a central source of pressurized air mounted on board of the vehicle, nor ducts for conveying the air from the source to the hub. Another object of the invention is to avoid the drawbacks and reduce costs connected with special high duty sealing devices.

These and other objects and advantages, that will be better understood in the following, are accomplished according to the invention by a hub-bearing assembly having the features defined in the appended claims.

### BRIEF DESCRIPTION OF THE DRAWINGS

A preferred, but not limiting embodiment of the invention will now be described, reference being made to the accompanying drawings, in which:

FIG. 1 is an axial cross-sectional view of a hub-bearing assembly according to the invention; and

FIG. 2 is an enlarged view of a detail of FIG. 1.

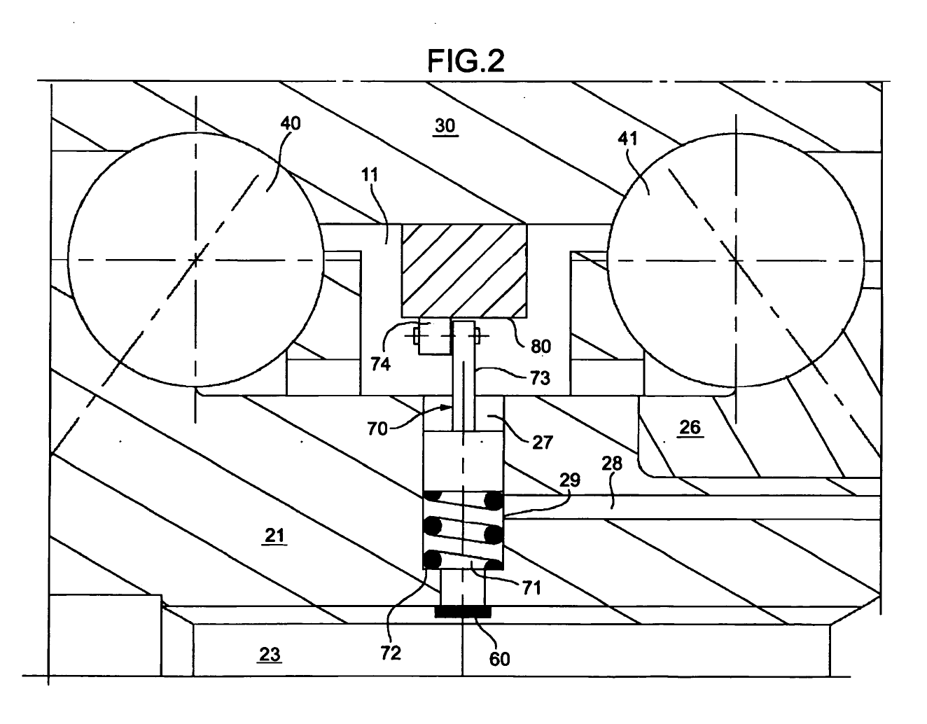

### DETAILED DESCRIPTION OF THE PREFERRED EMBODIMENT(S)

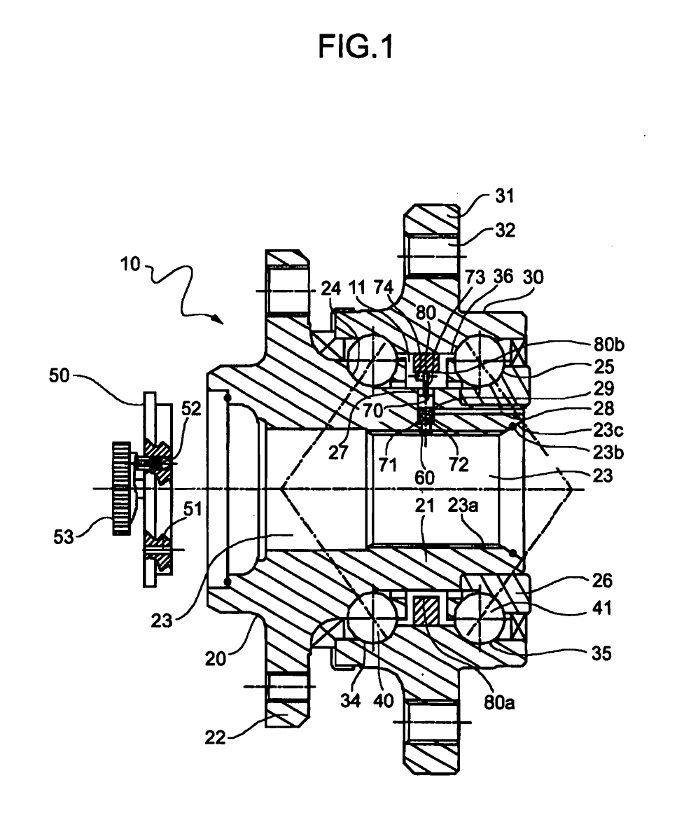

In FIG. 1, numeral 10 indicates overall a hub-bearing unit for a wheel of a motor vehicle, in this example a driving wheel (not shown). The unit 10 comprises a flanged, rotatable and radially inner hub 20, a non-rotatable and radially outer bearing race 30, and a dual set of rolling elements 40, 41 (in this example balls) radially interposed between the hub 20 and the outer race 30.

The outer race 30 forms a radial flange 31 extending in a radially outer direction with axial bores 32 for bolts for fastening to a suspension standard (not shown) of the vehicle. Furthermore, outer raceways 34, 35 for the rolling elements 40, 41 are formed in the outer race 30.

The hub 20 includes an axial tubular portion 21 and a flange 22 which extends in a radially outer direction in order to fix the wheel of the vehicle to the unit 10. The tubular portion 21 forms an inner cylindrical cavity 23.

A radially inner raceway 24 for the rolling elements 40 is formed directly in the outer cylindrical surface of the tubular portion 21, whereas another radially inner raceway 25 for the rolling elements 41 is formed by an annular element 26 that is fitted onto tubular portion 21.

A cover 50 of overall disc-like shape, described in detail hereinafter, hermetically closes the cylindrical cavity 23 on the axially outer side. On the axially inner side, or inboard side, the cavity 23 can be hermetically sealed in different ways, so as to define an airtight chamber. In the example of FIG. 1, which refers to a hub-bearing unit for a driving wheel, the cavity 23 is hermetically sealed by a constant-velocity joint (not shown) that may be coupled for rotation to the hub by means of splines 23a. In this case, hermetic sealing action is ensured by an annular gasket 23b fitted in a conical surface 23c of the hub. In other cases, according to the kind of coupling between the hub and the constant velocity joint, the sealing action on the inboard side may be insured by a circular cap (not shown) fitted onto the hub or into the constant-velocity joint near the hub. With hub-bearing unit for non-driven wheels, those skilled in the art will recognize that the cavity 23 may be closed on the inboard side by a radial wall formed by the hub itself or a further circular cap fitted on the inboard end of the hub.

According to the invention, a mechanical compressor for supplying pressurized air to the tyre of the associated wheel is integrated in the hub-bearing unit 10. The compressor comprises a piston 70 accommodated in an essentially radial passage 27 formed through the tubular portion 21 of the hub between the cavity 23 and an annular chamber 11 defined between the outer race 30, the hub 20, the inner race 26 and the two sets of balls 40, 41.

The piston 70 is urged in a radially outer direction by an associated spring 71 resting on a transversal shoulder 72 formed in passage 27. The piston has a stem portion 73 fitted with a roller 74 engaged against a driving surface 80 secured to the non-rotatable race 30. The surface for driving the piston is preferably a surface forming one or more undulations or lobes protruding in radially inner directions, so that relative rotation between the hub and the outer race will bring about reciprocating motion of the piston 70. As an alternative, the driving surface 80 may be a surface having an oval profile, or a circular profile eccentric with respect to the central axis of rotation x of the unit 10. At any rate, the driving surface 80 has, along its circumference, distinct zones having radially differentiated distances from the axis of the bearing. In other words, one can distinguish zones 80b (as shown in the upper part of the drawing) where the surface 80 is nearer to the central axis x, and zones 80a (lower part of the drawing) where the surface 80 is farther from said axis.

The surface 80 acts like a cam that cooperates with the piston 70. In bringing about its reciprocating motion, the piston 70 does not draw air in from the annular chamber 11, which is normally filled with lubricant grease, but from a side air intake channel 28, and sends the air into cavity 23. The inlet channel 28 is formed through the hub between the axially inner side thereof and the radial passage 27, and opens on this passage at a port 29 alternately opened and closed by the piston skirt.

Indicated schematically at 60 is one-way valve, fitted in the radial passage 27 downstream of the piston 70, to prevent the pressurized air within the cavity 23 from flowing back through the passage 27 and the intake channel 28.

Formed in the outer cap 50 is a passage 51 for tightly accommodating a connector (for example a valve connector, not shown) for conveying pressurized air from the cavity 23 to the tyre through a conduit (not shown). The outer cap 50 is advantageously associated with pressure adjusting means, such as a one-way pressure tuning valve 52, which can be adjusted manually by means of an external knob 53.

In operation, rotation of the hub 20 with respect to the driving surface 80 forces the piston 70 to bring about a reciprocating motion along the passage 27, carrying out a pumping action that lets pressurized air into the cavity 23. It will be understood the flow rate of air sent by the (small) piston 70 is rather low, whereby the invention can guarantee that the correct pressure is maintained in a tyre having a small puncture, or restore the pressure in a slightly under-inflated tyre. Upon reaching the pressure threshold determined by the setting of the pressure tuning valve 52, the air exits this valve, so that the tyre pressure will not exceed that prescribed and determined by the valve 52.

It will be appreciated that the invention allows to dispense with a centralized source of pressurized air mounted on board of the vehicle, as well as relevant channels for conveying pressurized air from the source to the hub. Since the air let into the central cavity of the hub bypasses the raceways and the bearing balls or rollers, the assembly according to the invention needs no special additional sealing devices. Finally, it is not necessary to perforate the outer race of the bearing.

The invention is not intended to be limited to the embodiment described and illustrated herein, which should be considered as an example of an embodiment of the hub-bearing assembly according to the invention. Rather, the invention may be modified with regard to the shape of arrangement of parts, constructional and functional details, as will be apparent to those skilled in the art. For example, the profile of the piston driving surface, as well as the number and arrangement of pistons and air channels may vary with respect to the embodiment described and illustrated herein. Particularly, the driving surface 80 for the piston may be provided, as in the illustrated example, by a cam means consisting of an annular element fixed into the outer race 30. According to a possible alternative embodiment (not shown), the driving surface 80 may be formed by an oval, or multi-lobed or circular eccentric groove formed directly (for example machined) in the axial cylindrical cavity 36 of the outer race 30.

What is claimed is:

1. A hub-bearing assembly allowing pressurized air to be supplied to the tyre of a vehicle wheel, the assembly comprising a hub-bearing unit having:
a rotatable hub fixable to the wheel of the vehicle,
a stationary bearing race fixable to the vehicle for rotatably supporting the hub about an axis,
an air cavity formed in the hub with at least one substantially radial passage for letting pressurized air into the cavity and an outlet for conveying pressurized air from this cavity to the tyre;
cam means integral with the stationary race and cooperating with at least one piston means accommodated in said at least one radial passage, wherein rotation of the hub brings about reciprocating motion of the piston means along the passage and lets pressurized air into the cavity.

2. The hub-bearing assembly of claim 1, further comprising a one-way valve, fitted in the radial passage downstream of the piston means, for preventing air within the cavity from flowing back outwardly through the passage.

3. The hub-bearing assembly of claim 1, wherein the radial passage communicates with an air inlet channel extending between the passage and an outer surface of the hub.

4. The hub-bearing assembly of claim 3, wherein the air inlet channel opens on the passage at a port alternately opened and closed by the piston means.

5. The hub-bearing assembly of claim 3, wherein said outer surface of the hub is a surface located at an axially inner side of the hub.

6. The hub-bearing assembly of claim 1, wherein said piston means is associated with an elastic means urging the piston means towards the cam means.

7. The hub-bearing assembly of claim 1, wherein said piston means is provided with a low friction means for engaging the cam means.

8. The hub-bearing assembly of claim 7, wherein said low friction means comprises a rolling element mounted on the piston means for rolling on the cam means.

9. The hub-bearing assembly of claim 1, wherein said outlet for conveying pressurized air from the cavity to the tyre is a bore formed through an outer cap hermetically sealing the cavity on the axially outer side of the assembly.

10. The hub-bearing assembly of claim 1, wherein said outlet for conveying pressurized air from the cavity to the tyre is associated with pressure limiting means, comprising a one-way pressure tuning valve.

11. The hub-bearing assembly of claim 10, wherein the pressure limiting means are associated with pressure adjusting means.

12. The hub-bearing assembly of claim 1, wherein said cavity is hermetically closed or closable on the axially inner side of the assembly.

13. The hub-bearing assembly of claim 1, wherein said cam means comprise a piston driving surface having at least one first surface zone radially farther from the axis and at least one second surface zone, angularly spaced from the first zone around the axis and radially nearer to this axis.

14. The hub-bearing assembly of claim 13, wherein the piston driving surface is a surface forming one or more undulations or lobes protruding in radial directions.

15. The hub-bearing assembly of claim 13, wherein the piston driving surface is a surface having an oval profile in a plane perpendicular to the axis of rotation.

16. The hub-bearing assembly of claim 13, wherein the piston driving surface is a surface having a circular and eccentric profile with respect to the axis of rotation.

17. The hub-bearing assembly of claim 1, wherein said cam means are formed as a single piece with the stationary race.

18. The hub-bearing assembly of claim 17, wherein said cam means comprise a groove formed in an axial cylindrical cavity of the stationary race.

19. The hub-bearing assembly of claim 1, wherein said cam means are formed by an annular element fixed to the stationary race.

20. The hub-bearing assembly of claim 1, wherein the hub-bearing unit comprises a dual set of rolling elements and wherein the cam means and the piston means are arranged in a radial plane axially intermediate the two sets of rolling elements.

21. The hub-bearing assembly for a motor vehicle wheel according to claim 1, wherein the hub-bearing unit includes an angular contact ball bearing having a dual set of bearing balls, the stationary race being the radially outer bearing race, the hub being a radially inner rotatable hub.
